(19) United States
(12) Patent Application Publication
(10) Pub. No.: US 2011/0292992 A1
(43) Pub. Date: Dec. 1, 2011

(54) AUTOMATING DYNAMIC INFORMATION INSERTION INTO VIDEO

(75) Inventor: Sudheer Sirivara, Redmond, WA (US)

(73) Assignee: MICROSOFT CORPORATION, Redmond, WA (US)

(21) Appl. No.: 12/790,669

(22) Filed: May 28, 2010

(51) Int. Cl. H04N 11/02

(52) U.S. Cl. 375/240.01; 375/E07.104

(57) ABSTRACT

Automated placement of supplemental information (such as advertisement) into a video presentation. A computing system automatically estimates suggestions for where and when to place supplemental information into a video. The suggestion is derived, at least in part, based on motion sensing within the video. A computing system may use the suggested temporal and spatial positions for the supplemental information, and reconcile this with accessing supplemental information rendering policy applicable to the video, to make a final determination on where and when to place the supplemental information.

### BACKGROUND

Digital video is widely distributed in the information age and is available in many digital communication networks such as, for example, the Internet and television distribution networks. The Motion Pictures Expert Group (MPEG) has promulgated a number of standards for the digital encoding of audio and video information. One characteristic of the MPEG standards for encoding video information is the use of motion estimation to allow efficient compression.

During the video encoding process, a video encoder uses motion estimation across video frames to determine the quantization metrics of a video sequence. Regions of a video frame in the spatial domain which are relatively static across multiple video frames are detected using motion vectors and such regions are quantized more efficiently for better compression.

Advertisements are often inserted into digital video. As an example, for Internet delivery of digital video, a banner advertisement is often positioned on the lower portion of the viewer spanning the horizontal reaches of the viewer. Sometimes, such banner advertisements may have a control for closing the advertisement. Nevertheless, the banner advertisement might obscure interesting portions of the video. For instance, sometimes subtitles, scores, or live news is delivered along the lower portions of the video. Such information may be obscured by the banner advertisement.

Another way of delivering advertisements in video delivered over the Internet is to have an advertisement of a limited duration (perhaps 15 or 30 seconds) (called a “pre-roll”) presented between the video of interest even begins. Sometimes, advertisements are injected into the video of interest at certain intervals. For instance, an episode of a television show might have two to six intervals of advertisement throughout the presentation. This form of advertisement is relatively intrusive as it stops or delays the video of interest in favor of an advertisement.

### BRIEF SUMMARY

At least one embodiment described herein relates to the placement of supplemental information into a video presentation. The supplemental information might be, for example, an advertisement, or perhaps additional information regarding the subject matter of the video, or any other information.

In one embodiment, a computing system automatically estimates suggestions for where and when to place supplemental information into a video. The suggestion is derived, at least in part, based on motion sensing within the video. For instance, if the video encoding process estimates motion, that motion estimation may be used to derive suggestions for information placement. The suggestions are then sent to a component (either within the same computing system or on a different computing system) that actually renders the supplemental information into the video.

In one embodiment, a computing system accesses suggested temporal and spatial positions for the supplemental information, accesses supplemental information rendering policy applicable to the video, and identifies a place and time to place the supplemental information reconciling the suggested temporal and spatial position with the supplemental information rendering policy.

This provides for greater flexibility on where and when the supplemental information may be placed in the video taking into consideration the motion present in the video and without requiring human intelligence to make the ultimate decision on where to render the supplemental information. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a flowchart of a method 200 for automatically suggesting temporal and spatial position for supplemental information into a video;

FIG. 3 illustrates a flowchart of a method for rendering supplemental information based on a suggested temporal and spatial position for supplemental information to be displayed in the video;

FIG. 4 illustrates one example of a video rendering in which supplemental information has been displayed; and

FIG. 5 illustrates another example of a video rendering in which supplemental information has been displayed.

### DETAILED DESCRIPTION

In accordance with embodiments described herein, the automated placement of supplemental information (such as advertisement) into a video presentation is described. A computing system automatically estimates suggestions for where and when to place supplemental information into a video. The suggestion is derived, at least in part, based on motion sensing within the video. A computing system may use the suggested temporal and spatial positions for the supplemental information, and reconcile this with accessing supplemental information rendering policy applicable to the video, to make a final determination on where and when to place the supplemental information.

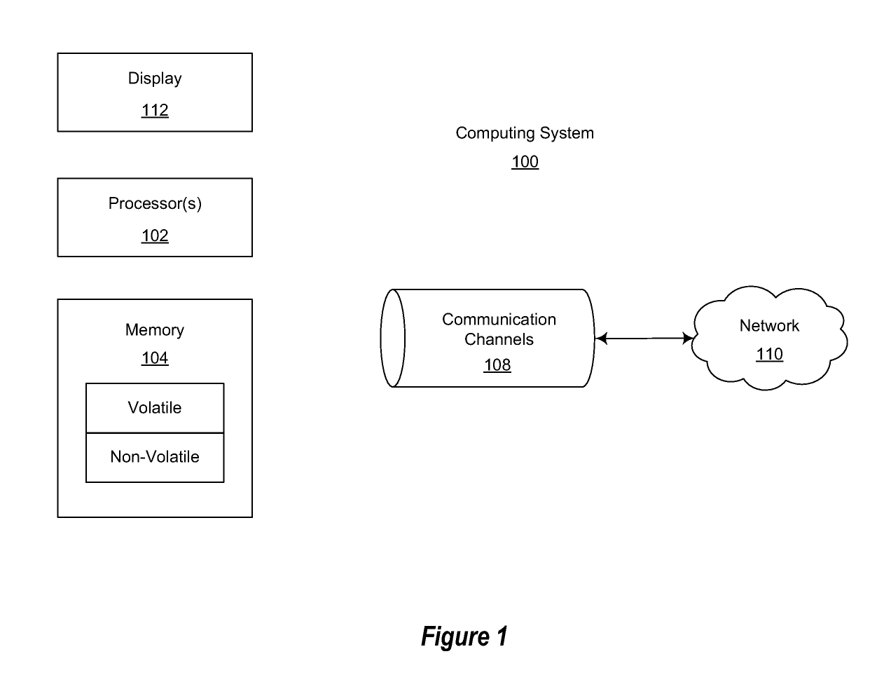

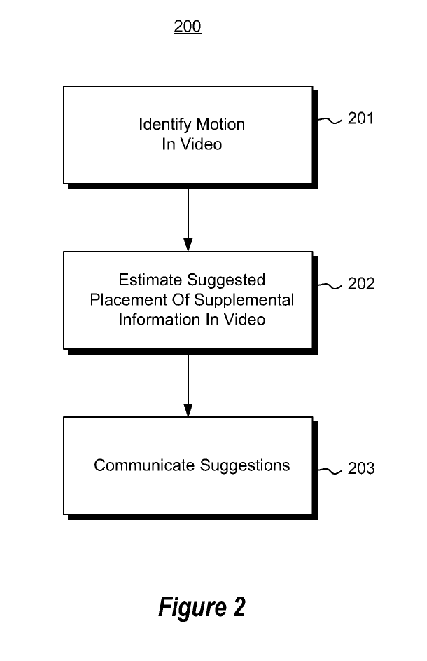

First, some introductory discussion regarding computing systems will be described with respect to FIG. 1. Then, the embodiments of the automated placement of supplemental information into a video will be described with respect to FIGS. 2 through 5.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. The computing system 100 also may include a display 112 that may be used to provide various concrete user interfaces, such as those described herein. Computing system 100 may also contain communication channels 108 that allow the computing system 100 to communicate with other message processors over, for example, network 110.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a flowchart of a method 200 for automatically suggesting temporal and spatial position for supplemental information into a video. The method 200 may be performed by a computing system 100 described with respect to FIG. 1. For instance, the computing system 100 may perform the method 200 at the direction of computer-executable instructions that are on one or more computer-readable media that form a computer program product. The supplemental information may be additional video information or non-video information.

The computing system automatically identifies motion in a video (act 201). This identification of motion may be performed, for example, by a video encoder. An MPEG-2 encoder, for example, estimates inter-frame motion by finding blocks of pixels in one frame that appear similar to a similarly sized block of pixels in a subsequent frame. This allows the MPEG-2 encoder to encode this motion, with a motion vector representing movement from one frame to the subsequent frame, and difference information representing slight differences in the block comparing the two frames. This allows for efficient compression. The encoding may, for example, by performed by a computing system such as the computing system 100 of FIG. 1. The video may be previously existing video (such as a television show). However, the principles of the present invention may also be performed for live video feeds (such as live television, and of a live video camera shot).

Motion could also represent information regarding which portions of the video are most interesting. Accordingly, the motion information used in the encoding process may be used assist in the formulation of suggestions for where and when to place supplemental information such as an advertisement.

For example, consider an example in which the video is showing a video of a race car racing by a stationary city setting. The stationary setting is relatively still, whereas the racing car is in motion. In this case, the object in motion may be inferred to be the object that the viewer is most likely to be focused on. Thus, the suggestion for the placement may, in some cases, avoid areas that appear to be in motion, to thereby reduce the risk that supplemental information will be placed over the objects of most interest in the video. Thus, where most of a scene is stationary, but a portion is in motion, the object in motion might be inferred to be a focal object of the video, and thereby be avoided.

As another example, suppose the video is an overhead shot of a military aircraft flowing low altitude over terrain, in which the camera follows the airplane closely such that the airplane does not spatially move significantly from one frame to the next, but the terrain is consistently moving from one frame to the next. In this case, if most of the scene is consistently in motion, and a portion is not, the portion that is not may be inferred to be the focal object in the scene.

These are just two examples, but the principles is that by using motion estimation, computational logic may be applied to infer the most likely focal object or objects within a particular video scene. Then, to avoid too intrusive placement of the supplemental information in the video, the supplemental information is placed in a position and time in which the focal object(s) of the video scene are not hidden by the supplemental information.

Once the motion of the video is identified (e.g., through video encoding), the computing system determining a suggested temporal and spatial position for supplemental information (act 202) to be displayed in the video based at least in part upon the identified motion in the video. For instance, in the example of a car speeding passed a stationary urban setting, the supplemental information may be positioned spatially and temporally such that the supplemental information is not at any point obscuring any portion of the moving car. Likewise, in the example of the overhead video of an airplane, the supplemental information may be placed over the moving terrain, but not over the military aircraft. The computation of the suggested temporal and spatial position may occur at a server, at a client, in a collection of computing systems (e.g., in a cloud), or any other location.

The supplemental information may be any information that anyone wants to be placed over a portion of the video. The supplemental information need not, but may, be related to the subject matter of the video. The supplemental information may be, for example, an advertisement. The supplemental information may, but need not, include a control that may be selected by a viewer to display further supplemental information. For instance, the control may be associated with a hyperlink that may be selected to take the viewer to a web page.

The suggested spatial placement may be described using any mechanism that may be used to identify a pixel range for the placement. The suggested spatial placement may represent this information directly using pixel positions, or may use any other information from which the pixel position may be inferred. The suggested spatial placement may be a rectangular region, but may also be a non-rectangular region of any shape and size. The suggested spatial placement may be the same size as the supplemental information that may be placed there, but may also be larger than the supplemental information. In the case of the suggested spatial placement, the rendering computing system may perhaps select a position within the suggestion spatial placement within which to place the supplemental information if the rendering computing system decides to use that suggested spatial placement.

The temporal placement may be described using any mechanism that may be used to identify the relative time within the video that the supplemental information may be displayed. The suggested temporal placement may be the same time as the supplemental information is to be displayed, but may also be longer than the supplemental information is to be displayed. In the latter case, the rendering computing system may choose an appropriate time within the suggested temporal placement in which to render the supplemental information.

The suggestion process may also account for content provider configuration, allowing the content provider to influence the suggestion. For instance, perhaps the producer of the video is limiting supplemental information to certain spatial and temporal positions within the video. The suggestion process will then avoid making suggestions outside of the spatial or temporal windows directed by the producer of the video. The provider of the supplemental information might also place certain restrictions on where and when the supplemental information may be placed within the video. For instance, the supplemental information provider might specify that the supplemental information should be provided some time from 10 minutes to 30 minutes into the video, and that the supplemental information is to not occur outside of the corner regions of the video. In that case, if 30 seconds of supplemental information are to be provided, the suggestion process might determine which corner of the display has the least motion of a 30 second period, and then suggest that corner as the spatial suggestion and the found 30 second period as the temporal suggestion. Of course, in some circumstances, the suggestions process may identify the corner with the most motion as being the area in which to place the supplemental information in cases in which motion implies a lower probability of being the focal object.

Once the suggested temporal and spatial position is determined, that temporal and spatial information is communicated (act 203) to a supplemental information rendering system that inserts the supplemental information into the video. That supplemental information rendering system may be on the same computing system as the computing system that generated the suggestion. However, the supplemental information rendering system may also be on a different computing system that may also be structured as described with respect to FIG. 1. In that case, the supplemental information rendering system may also perform its processes as directed by computer-executable instructions provided on one or more computer-readable media within a computer program product.

In one embodiment, the computing system that renders the supplemental information into the video already has a copy of the video. In other embodiments, the computing system that renders the supplemental information does not previously have a copy of the video. In that case, the computing system that provides the suggestions regarding temporal and spatial placement may also provide the video itself. The suggestions may be encoded within the video as part of the encoding scheme of the video. Alternatively, the suggested temporal and spatial placement may be provided in a file container associated with the video, or perhaps be carried as metadata associated with the video. The suggested temporal and spatial placement may be entirely separately provided in a separate channel as the video was provided.

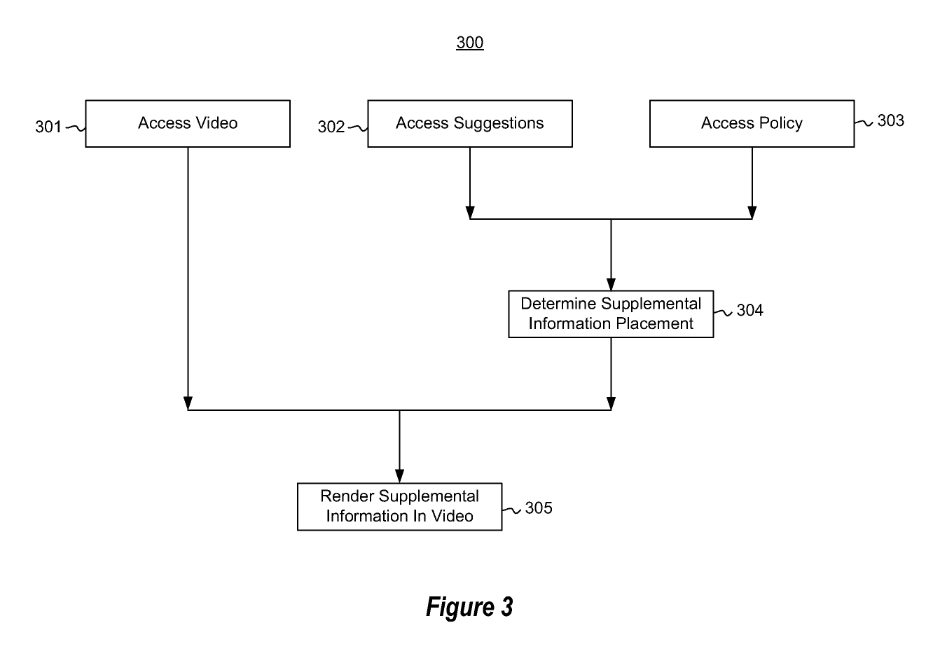

FIG. 3 illustrates a flowchart of a method 300 for rendering supplemental information based on a suggested temporal and spatial position for supplemental information to be displayed in the video. The method 300 may be performed by, for example, the supplemental information rendering system previously described as receiving the suggested temporal and spatial placement.

If the supplemental information rendering system did not already have the video, the system accesses the video (act 301) either from the computing system that generated the suggestions, or from some other computing system. In one embodiment, the computing system may access the video from a video camera. The video camera itself may also be capable of performing the method 300 in which case, the methods 200 and/or 300 may perhaps be performed all internal to the video camera. The supplemental information rendering system also accesses the suggested temporal and spatial position (act 302). Since there is no time dependency between the time that the system access the video (act 301), and the time that the system accesses the suggested positions (act 302), acts 301 and 302 are illustrated in parallel, though one might be performed before the other.

The supplemental information rendering system also accesses supplemental information rendering policy applicable to the video (act 303). This policy may also be set by the content provider (e.g., the video producer and/or the provider of the supplemental information).

The supplemental information rendering system also determines where and when to place the supplemental information within the video based on the suggestions and based on the accessed supplemental information rendering policy (act 304). This supplemental information rendering policy may restrict where or when the supplemental information may be placed. Then, the supplemental information may be rendered in the video at the designated place and time (act 305).

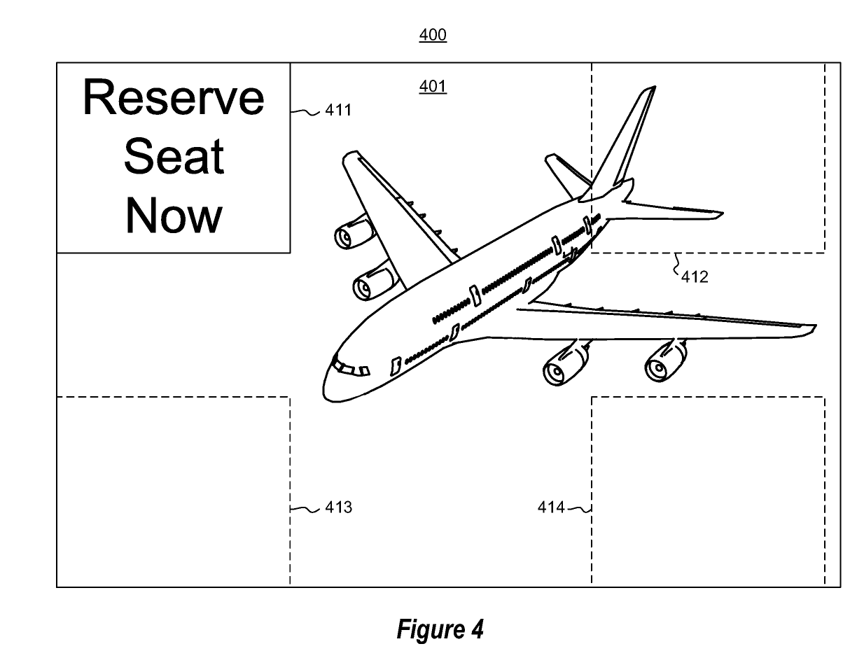

FIG. 4 illustrates one example of a video 400 rendering in which supplemental information has been displayed. The video 400 displays video content 401 (in this case, a video of an airplane in transit). In the case of FIG. 4, there are four possible places in which suggestions may be made including the four corner regions 411, 412, 413 and 414. The four possible places may have been inferred based on the policy that was set by the content provider when the suggestion was being made. Here, since there is the least motion detected for corner region 411, that region is suggested as being the place for supplemental information placement. In this case, the user might select the “Reserve Seat Now” icon to book a vacation.

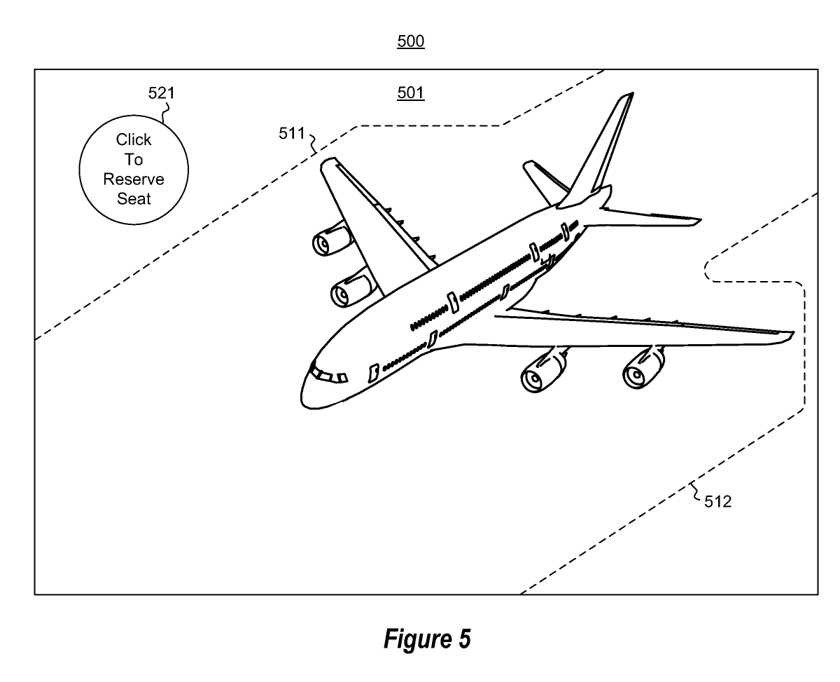

FIG. 5 illustrates one example of a video 500 rendering in which supplemental information has been displayed. The video 500 displays video content 501 (once again, a video of an airplane in transit). In the case of FIG. 2, there are two possible regions which have been suggested for supplemental information placement—1) to the upper left of line 511, or 2) to the lower right of line 512). Here, the supplemental information 521 was selected to appear within region 511 at the illustrated location. Note that the regions 511 and 512 are irregularly shaped, demonstrating that the suggested regions need not be rectangular. Likewise, the supplemental information 521 is not rectangular-shaped, nor shaped the same as the suggested region, demonstrating that the broadest principles described herein do not require dependence between the shape and size of the supplemental information and the suggested region for placement.

Accordingly, the principles described herein provide for an automated mechanism for suggesting placement and/or placing supplemental information in a video. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable media having thereon computer-executable instructions that, when executed by one or more processors of the computing system, cause a computing system to perform the following:
an act of automatically identifying motion in a video;
an act of determining a suggested temporal and spatial position for supplemental information to be displayed in the video based at least in part upon the identified motion in the video; and
an act of communicating the suggested temporal and spatial position to a supplemental information rendering system that inserts information into the video.

2. The computer program product in accordance with claim 1, wherein the supplemental information is an advertisement.

3. The computer program product in accordance with claim 1, wherein the supplemental information is a hyperlink.

4. The computer program product in accordance with claim 1, wherein the suggested spatial position is described based on pixel ranges in each of the vertical and horizontal directions with respect to a video orientation.

5. The computer program product in accordance with claim 1, wherein the suggested temporal position is described as a specific time range with respect to a video time reference.

6. The computer program product in accordance with claim 1, wherein the computer-executable instructions further cause the following:
an act of communicating the video to the supplemental information rendering system.

7. The computer program product in accordance with claim 6, wherein the act of communicating the suggested temporal and spatial position to a supplemental information rendering system that inserts information into the video object having metadata comprises:
an act of communicating the suggested temporal and spatial position in a file container associated with the video.

8. The computer program product in accordance with claim 6, wherein the act of communicating the suggested temporal and spatial position to a supplemental information rendering system that inserts information into the video object having metadata comprises:
an act of encoding the temporal and spatial position in the video encoding.

9. The computer program product in accordance with claim 1, wherein the an act of determining a suggested temporal and spatial position for supplemental information to be displayed in the video based at least in part upon the identified motion in the video comprises:
an act of accessing positioning policy defined by a content provider of the video, wherein the act of determining a suggested temporal and spatial position is also based on the accessed positioning policy.

10. The computer program product in accordance with claim 9, wherein the positioning policy specifies spatial restrictions for the suggested temporal and spatial position.

11. The computer program product in accordance with claim 1, wherein the an act of determining a suggested temporal and spatial position for supplemental information to be displayed in the video based at least in part upon the identified motion in the video comprises:
an act of determining which of a plurality of possible locations have less motion over a temporal position.

12. The computer program product in accordance with claim 1, wherein the an act of determining a suggested temporal and spatial position for supplemental information to be displayed in the video based at least in part upon the identified motion in the video comprises:
an act of determining which of a plurality of possible locations have more motion over a temporal position.

13. The computer program product in accordance with claim 1, wherein the act of automatically identifying motion is performed by a video encoder during encoding of the video.

14. A computer program product comprising one or more computer-readable media having thereon computer-executable instructions that, when executed by one or more processors of the computing system, cause a computing system to perform the following:
an act of accessing a video;
an act of accessing a suggested temporal and spatial position for supplemental information to be displayed in a video; and
an act of accessing a supplemental information rendering policy applicable the video; and
an act of determining where and when to place supplemental information in a video based on a reconciliation of the suggested temporal and spatial position and the supplemental information rendering policy.

15. The computer program product in accordance with claim 14, wherein the supplemental information rendering policy restricts where the supplemental information may be placed.

16. The computer program product in accordance with claim 14, wherein the supplemental information includes an advertisement.

17. The computer program product in accordance with claim 14, wherein the supplemental information includes a control.

18. The computer program product in accordance with claim 17, wherein the control is selectable to display further supplemental information.

19. The computer program product in accordance with claim 17, wherein the control is a hyperlink that is selectable to navigate to a web page.

20. A computing system comprising:
a first computing system; and
a second computing system communicatively coupled to the first computing system over a network,
wherein the first computing system is configured to identify motion in a video, determining a suggested temporal and spatial position for supplemental information to be displayed in the video based at least in part upon the identified motion in the video, and communicate the suggested temporal and spatial position to the second computing system, and
wherein the second computing system is configured to access the suggested temporal and spatial position, access a supplemental information rendering policy applicable the video, determining where and when to place supplemental information in the video based on a reconciliation of the suggested temporal and spatial position and the supplemental information rendering policy, and render the supplemental information into the video.
